(19) United States
(12) Patent Application Publication
(10) Pub. No.: US 2024/0351676 A1
(43) Pub. Date: Oct. 24, 2024

(54) AIRCRAFT WITH AIRCRAFT SECTION

(71) Applicant: Airbus Operations GmbH, HAMBURG (DE)

(72) Inventors: Carsten PAUL, HAMBURG (DE); Cord HAACK, HAMBURG (DE); Sergej KAUFMANN, HAMBURG (DE)

(21) Appl. No.: 18/421,130

(22) Filed: Jan. 24, 2024

(30) Foreign Application Priority Data
Jan. 26, 2023 (DE) 102023101905.8

(51) Int. Cl. B64C 1/06; B64D 37/04; B64D 37/30

(52) U.S. Cl. CPC B64C 1/069; B64D 37/04; B64D 37/30

(57) ABSTRACT

An aircraft section for aircraft. The aircraft section comprises at least one flight component, such as a wing assembly and a tail assembly, and a first fuselage component. The flight component is mounted on the first fuselage component. The first fuselage component has a first coupling point designed for releasable connection to a second coupling point on a second fuselage component, in order to form an integrated fuselage of an aircraft when in a coupled state. The first coupling point provides a mechanical coupling with a second coupling point, forms a system infrastructure interface, and provides a data transmission device for integrity checking when the aircraft section is coupled to another aircraft section. The first coupling point likewise provides positioning sensors for guided docking of the aircraft section with another aircraft section in a target position.

### CROSS-REFERENCES TO RELATED APPLICATIONS

This application claims the benefit of German Patent Application Number 10 2023 101 905.8 filed on Jan. 26, 2023, the entire disclosure of which is incorporated herein by way of reference.

### FIELD OF THE INVENTION

The present invention relates to an aircraft section for an aircraft, an aircraft with a first and a second aircraft section, a hydrogen refueling system for aircraft, and a method for providing an aircraft.

### BACKGROUND OF THE INVENTION

In connection with the economic operation of aircraft, increasing consideration is being given to turn-around times, in other words the time required in order to perform the necessary actions between two flights. The turn-around time is also referred to as the ground time. The term refers to the amount of time an aircraft spends on the ground (referred to as ground turnaround) and the handling operations that take place during this time, such as cleaning work, loading and unloading, catering, and pushback, i.e. the external maneuvering of the aircraft. In addition to passenger boarding and disembarkation, this therefore also involves the loading and unloading of cargo and the servicing and provisioning of the passenger cabin. Another point is the refueling of the aircraft. In addition to this, there will be any repair, maintenance, and servicing activities that are required. It has been shown that there is a need for optimization in this respect, in order to ensure that the time the aircraft spends on the ground is used as efficiently as possible.

### SUMMARY OF THE INVENTION

An object of the present invention is to provide an aircraft that offers improved efficiency for the plurality of activities required during the time spent on the ground between two flights missions.

This object may be achieved by the subject matter of one or more embodiments described herein. It should be noted that the aspects of the invention described below also apply to the aircraft section, the aircraft, the hydrogen refueling system, and the method for providing the aircraft.

According to the present invention, an aircraft section is provided for an aircraft. The aircraft section comprises at least one flight component from the group comprising a wing assembly and a tail section and a first fuselage component. The at least one flight component is mounted on the fuselage component. In addition, the first fuselage component has a first coupling point designed for releasable connection to a second coupling point on a second fuselage component, in order to form an integrated fuselage of an aircraft when in a coupled state. The first coupling point provides a mechanical coupling with a second coupling point and forms a system infrastructure interface. In addition, the first coupling point provides a data transmission device for integrity checking when the aircraft section is coupled to another aircraft section. Moreover, the first coupling point provides positioning sensors for guided docking of the aircraft section with another aircraft section in a target position.

Providing an aircraft section allows, for example, separate handling of aircraft sections and therefore enables greater efficiency for the activities described above, for example. An aircraft section may, for example, be arranged at the boarding area, allowing passengers to embark and disembark while the other aircraft section is being refueled, for example. The coupling point ensures that the required integrity exists, as soon as the two aircraft sections are connected to one another.

Providing an aircraft section makes it possible for the aircraft section to be refueled away from the gate, for example. The aircraft section can also be provided as an aircraft section that has already been refueled, for example, in order to shorten the time between two flights still further.

The coupling point can also be referred to as a quick-release system.

According to one example, the data transmission device comprises transmitter and receiver units, with which data can be exchanged bidirectionally with a complementary second coupling point of another aircraft section.

According to one example, the positioning sensors are designed with sensors and controls that allow position sensing, steering, and centering of the first aircraft section with another aircraft section relative to one another.

According to one example, the data transmission device and the positioning sensors use the same shared data communication device.

According to one example, the aircraft section also comprises a hydrogen tank device with at least one tank unit for storing hydrogen. The at least one tank unit forms a structurally integrated unit with the first fuselage component. Hydrogen lines are provided which are configured to transport hydrogen from the hydrogen tank device of the first aircraft section to consumers in the other aircraft section. The hydrogen lines are designed for reversible coupling with the other aircraft section, with a first line coupling at the first coupling point for connection to a complementary second line coupling.

Providing an aircraft section with a hydrogen tank device offers the advantage that this aircraft section can be refueled remotely, for example. At the same time, this makes for easier integration of hydrogen operation into the infrastructure of existing airports, including their surroundings, hangars, aprons, and parking areas, without the need for a completely new structural design. New hydrogen-powered aircraft can be used in compliance with the safety measures, turnaround times, boarding, and service times dictated by today's airports, as refueling facilities can be installed remotely from the existing building structure. This also allows mixed operation between conventionally and hydrogen-powered aircraft. Aircraft sections with a hydrogen tank device can be arranged, refueled, maintained, and also stored at a separate location, i.e., remote from the existing buildings, and/or with appropriate safety measures in place. This accommodates the fact that hydrogen-powered aircraft with a hydrogen tank and hydrogen propulsion system require more frequent inspection and maintenance. Aircraft components such as the tank itself must be easily replaceable and quickly accessible, for example. This can be made possible by providing separable sections of hydrogen-powered aircraft.

According to the present invention, an aircraft is also provided that comprises a first aircraft section and a second aircraft section. The second aircraft section is complementary to the first aircraft section and forms an integrated aircraft when coupled with the first aircraft section.

According to one example, a plurality of first or second aircraft sections is provided. The two aircraft sections are configured in such a manner that the first and/or second aircraft section can be exchanged with at least one other first and/or second aircraft section, in order to form a structurally and functionally integrated aircraft.

According to the present invention, a hydrogen refueling system for aircraft is also provided. The system comprises an aircraft according to any one of the preceding examples. One of the two aircraft sections of the aircraft is designed with a hydrogen tank device. In addition, the system comprises at least one transport system for one of the two aircraft sections and a hydrogen refueling station. The aircraft section can be uncoupled from the other aircraft section along with the hydrogen tank device, and the transport system can create a spatial distance between the two aircraft sections. The aircraft section with the hydrogen tank device can be refueled at a spatial distance from the other aircraft section. The aircraft sections can then be (re) coupled, in order to form a refueled integrated aircraft.

According to the present invention, a method for providing an aircraft is also provided. The method comprises the following steps: providing a first aircraft section and providing a second aircraft section which is complementary to the first aircraft section. The method further comprises positioning the first and second aircraft sections in relation to one another in a target position and mechanically coupling the first and second aircraft sections in the target position. In addition, the method comprises connecting the system infrastructure of the first and second aircraft sections and performing an onboard integrity check of the aircraft. The method further comprises releasing flight operations when integrity is confirmed.

According to an example of the method, one of the two aircraft sections also comprises a hydrogen tank device, and both aircraft sections form an integrated aircraft. Before the provision or positioning step, the aircraft section with the hydrogen tank device is uncoupled from the aircraft section without the hydrogen tank device and the aircraft section with the hydrogen tank device is replaced by an aircraft section with a refueled hydrogen tank device.

One option involves refueling the hydrogen tank device remotely from the other aircraft section.

An advantage of this approach is, for example, that accessibility, operational time spent by the aircraft on the ground, specific hydrogen-related conditions such as cooling, refueling, and airport safety aspects, as well as the downtime of the tank unit and, where applicable, fuel cells, and their frequent maintenance, inspection and accessibility by the operational passenger part of the aircraft are treated separately. As a result, the actual flight operation remains unaffected, the passenger cabin remains intact as a unit, and refueling can be carried out remotely, separately, and added just-in-time. The connection of the coupling point is constructed in such a manner that the integrity of the aircraft is established following assembly, the integrity is functionally tested, and all structural and mechanical requirements are automatically met. The systems are automatically coupled, functionally tested by means of sensors, and monitored through visual inspection. There are multiple redundancies of critical systems, for example.

In one example, it is provided that the coupling points of the first aircraft section and the second aircraft section form a quick-release mechanism at the transverse joint of the two adjacent fuselage sections. The aircraft may, for example, have a single-aisle fuselage structure, i.e., a passenger area with a (usually) central aisle. In another example, the aircraft has a dual-aisle fuselage structure, for example.

The aircraft sections form two units, so to speak. The one aircraft section or unit, for example, comprises the passenger pressurized fuselage with the cockpit and the wings with the engines. The other aircraft section or unit, for example, comprises the hydrogen tank and the tail sections.

According to one aspect, it is provided that the rear section should be separated from the front unit or section during landing and when the tank is empty, and then a refueled unit or section reattached. The connection is facilitated by the coupling point, e.g., rapid detachability is provided, in order to minimize the turnaround time on the ground. During this period of time, activities such as passenger and baggage or freight unloading and loading, as well as aircraft refueling, take place.

The uncoupling and displacement of the section with the tanks from the passenger section by the coupling point allows for simplified refueling, for example outside the passenger area, within a reasonable time frame, and in a safe environment, in relation to hydrogen and its specific conditions, which takes account of criteria such as cold, pressure, and tank technology, for example.

The coupling point also allows for the separation and connection of the sections to be configured in such a manner that the integrity of the aircraft with the structure and its control units is secure, rapid, and also automatic.

In one example, sensors located entirely on board the sections check, monitor, and test the process of separation and connection, e.g., automatically, so that a safe new (flight) mission can take place.

In one variant, an option is provided where the rear fuselage is folded up or away, the hydrogen tanks are removed, refueled, and then reinserted, and the rear is closed again. The separation point works with the same coupling points. A possible separation area for the sections is, for example, the pressure bulkhead as the pressure fuselage closure to the passenger compartment, or the attachment of the connecting elements to the rear fuselage with the tank.

The coupling point has mechanically openable bolt connections, for example, as well as disconnections in the systems, such as lines or control connections, for example. In this way, the rear area is released for removal or for uncoupling.

For example, for transportation, i.e. moving the rear section back and forth, a kind of tug is provided, on which the rear section is supported by a transport frame and guided by a guidance system, for example a laser guide beam, for example for refueling. The refueled unit is then brought back to the other unit, i.e. the aircraft section, by means of the transport frame. The unit is then docked using a laser guide beam, wherein precise positioning is achieved via the fuselage centering pins. All connections are closed automatically, for example, and are checked using sensors, and released for the new mission when “integrity established” is displayed in the cockpit. The sensor system is designed in such a manner as to monitor the “integrity” of the overall fuselage throughout the entire mission, i.e., ensuring the requirement for unity.

According to one aspect, it is provided that hydrogen-powered aircraft, despite the operational constraints associated with the volatile H₂ that has to be cooled to extremely low temperatures, while simultaneously having multiple times the volume of current fuels for the same energy output, can still maintain approximately similar turnaround times on the ground. For example, a special refueling facility is provided on the airfield, which facilitates the necessary decentralized infrastructure associated therewith.

Based on the current infrastructure of airports and their surroundings, including their hangars, aprons, and parking areas, this allows for a new design for use by hydrogen-powered aircraft too. With existing security and typical turnaround times, boarding, and service times, roughly equivalent utilization is guaranteed. A mixed operation based on current designs is also possible.

The design of the coupling points as quick-release mechanisms at the transverse joints of fuselage structures, so to speak, further enables more frequent inspection and maintenance of hydrogen aircraft with their unique tank and propulsion system. Moreover, components such as the tank itself are more easily replaceable as a whole unit and are quickly accessible, since the entire section is detachable.

The separation point of the coupling point, for example, is a kind of bayonet lock-type connection of entire fuselage sections to one another. It allows the entire rear fuselage, including tail sections, to be separated, removed from the front passenger compartment with wings and landing gear, and another rear section to be reassembled quickly, for example in a controlled manner, to create a complete aircraft as a unit again.

A similar separation can also occur alternatively behind the tank, so that only the section with the tail sections is removed, and the tank unit can be exchanged. The separation point itself works automatically. Pins and locking elements establish the load-bearing structural connections.

The resulting advantage is a quickly detachable connection in relation to the turnaround time on the ground that typically has to be observed, in order to be able to meet the required turnaround time on the ground, which includes passenger boarding and disembarkation, baggage handling, and refueling of the aircraft, for example.

Furthermore, another advantage is ensuring risk-free refueling outside the passenger area within a reasonable and necessary time frame, and in a safe environment in relation to hydrogen and its specific conditions (cold, pressure, tank technology, etc.).

Another advantage that results with future hydrogen-powered aircraft is that at least some of the operational constraints posed by the volatile medium hydrogen that has to be cooled to extreme temperatures of around −253° C. are eliminated. At the same time, with four times the volume of current fuels for the same energy output, a comparable turnaround time, or time between missions, on the ground can be maintained.

Moreover, the advantage of separating and reconnecting the front and rear units is that the integrity of the aircraft with its structure and control units can be established securely and rapidly automatically.

Furthermore, the advantage arising from the sensors that automatically monitor, accompany, and test the process of separation and connection is the execution of a safe new mission.

These and other aspects of the present invention will become apparent from the embodiments and examples described below and will be illustrated by them.

### BRIEF DESCRIPTION OF THE DRAWINGS

Exemplary embodiments of the invention are described below with reference to the following drawings:

FIG. 1a shows schematically an example of an aircraft section with a coupling point.

FIG. 1b also shows schematically an example of an aircraft section with a coupling point.

FIG. 2 shows schematically a detailed view of a coupling point.

FIG. 3 shows schematically an example of an aircraft section with a hydrogen tank device.

FIG. 4 shows schematically an example of an aircraft with two aircraft sections.

FIG. 5 shows schematically an example of an aircraft with a foldable aircraft section and removable tank units.

FIG. 6 shows schematically an example of a hydrogen refueling system for aircraft.

FIG. 7 outlines basic steps of an example of a method for providing an aircraft with a quick-release system.

### DETAILED DESCRIPTION OF THE PREFERRED EMBODIMENTS

Certain embodiments will now be described in greater detail with reference to the accompanying drawings. In the following description, the same reference signs are used for the same elements, even in different drawings. The matters defined in the description, such as detailed constructions and elements, for example, serve to assist with the comprehensive understanding of the exemplary embodiments. Functions or constructions that are also known are not described in detail, as they would obscure the embodiments with unnecessary details. Moreover, when they precede a list of elements, expressions such as “at least one of” change the entire list of elements and not individual elements in the list.

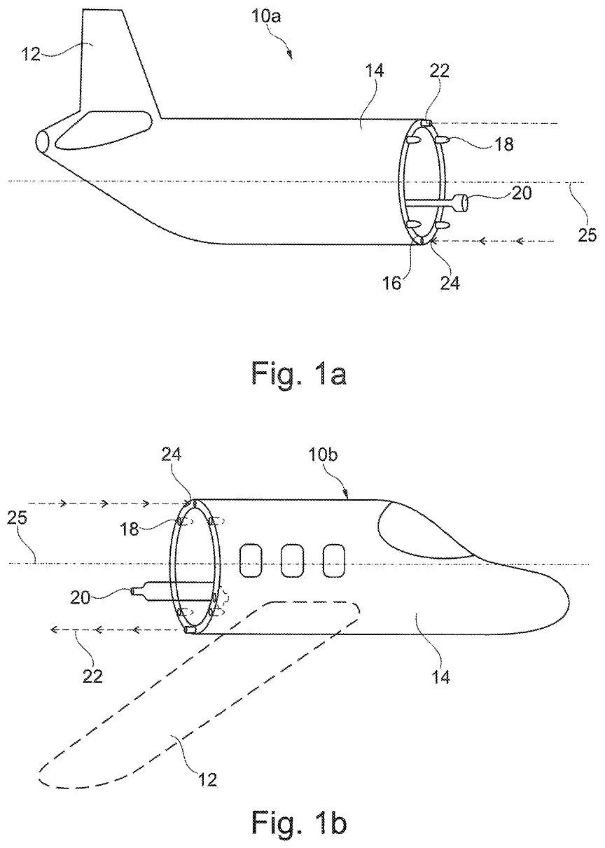

FIGS. 1a and 1b show schematically an example of an aircraft section 10a and 10b with a coupling point. The aircraft sections 10a and 10b comprise at least one flight component 12 from the group comprising a wing assembly and a tail assembly. Furthermore, the aircraft section comprises a first fuselage component 14. The at least one flight component is mounted on the fuselage component. The first fuselage component has a first coupling point 16 that is designed for detachable connection to a second coupling point on a second fuselage component, in order to form an integrated fuselage of an aircraft in the coupled state. The first coupling point provides a mechanical coupling 18 with a second coupling point. Furthermore, the first coupling point forms a system infrastructure interface 20 and provides a data transmission device 22 for an integrity check when the aircraft section is coupled to another aircraft section. The first coupling point also provides a positioning sensor system 24 for guided docking of the aircraft section with another aircraft section in a target position 25.

The term “aircraft section” refers to a portion or segment of an aircraft. The aircraft section, or section, already includes all components, installations, coverings, etc., necessary for flight operations. The section is a segment or part of a finished aircraft. The term section does not refer to a section within the aircraft but to a portion of the aircraft that can actually be detached (by means of the coupling point).

The term “flight component” refers to parts of the structural elements necessary for flying which are referred to as the flight structure. The flight structure comprises the components responsible for lift, also known as the wing assembly. These may include wing surfaces, also called wings. The flight structure also includes the components responsible for control during flight, which are also known as the tail assembly. These may be horizontal or vertical stabilizers, for example. The term flight component 12 refers to a part of the flight structure.

The term “fuselage component” refers to a part of the aircraft's fuselage structure. The fuselage is used, for example, to accommodate the load that is being transported, such as passengers, luggage, goods, etc.

The fuselage component 14 comprises a fuselage support structure and an exterior covering, for example. The fuselage component may also be referred to as the first part of a fuselage structure. The fuselage structure may also be referred to as a fuselage or fuselage framework. The part of the fuselage structure can be referred to as the fuselage substructure.

The term “coupling point” refers to a detachable connection point between two aircraft sections. The term “coupling” already points to the mechanical connection and attachment of the systems. The first coupling point may also be referred to as the first coupling region or first coupling half.

In one example, the first coupling point of the first aircraft section and the second coupling point of the other aircraft section are configured to be complementary to one other.

The term “mechanical coupling” relates to a connection in which mechanical forces can also be transmitted in both directions.

The term “system infrastructure interface” refers to the interface of the aircraft's infrastructure. This includes electrical lines for power supply or data and control signal transmission, for example. These may also be supply and disposal lines, for example, such as for fresh water, wastewater, or fuel. Another example is air ducts for supplying air to the cabin area.

The term “system infrastructure interface” also relates, for example, to the transmission of flight operation data, such as data or signals from avionics. The system infrastructure interface 20 also comprises, for example, interfaces for transmission elements of control inputs for flight operations.

The term “data transmission device” relates to devices for transmitting data in both directions, i.e., transmitting and receiving data. These are particularly used for integrity checks. For this purpose, data processing devices are provided in both sections, allowing bi-directional integrity checks to be carried out.

The term “positioning sensor system” relates to devices that allow an actual position of the two aircraft sections relative to each other to be detected. The positioning sensors also allow a deviation from a desired position, for example a target position, to be determined, in order to be able to carry out precise positioning.

The term “target position” relates to the position of the two aircraft sections relative to each other in which coupling leads to an integrated state of the aircraft.

The term “integrity” relates to the state of an aircraft in which it meets all requirements and is generally usable for flight operations. The integrity of an aircraft is a kind of technical acceptance or guarantee of functionality. Integrity exists when the systems are configured and no longer subject to undetected changes.

The aircraft section is designed to form a structurally and functionally integrated aircraft unit with another/the other aircraft section, i.e., a first and another aircraft section complement one other to create “mission-capable”, in other words operable, aircraft integrity. The two aircraft sections complement one other in this case, because neither of the two aircraft sections is functional as an aircraft on its own.

For example, the coupling point is configured to allow at least partial uncoupling and complete coupling with at least a complete reconstruction of the flight segments and their infrastructure to form an airworthy aircraft. The coupling points are configured, for example, to maintain a structural and functional unit of the aircraft after complete reconstruction, by minimizing structural and functional deviations from an actual state of the aircraft before at least one automatic partial uncoupling and the actual state of the aircraft after complete automatic reconstruction.

The primary structure is fundamentally part of the approval of an aircraft. By providing a first and another aircraft section, there is also a “disassembly” of the primary structure, i.e., the primary structure is no longer completely intact as such. The restoration of the primary structure only occurs through coupling. This structural approval issue is addressed by the integrity check and monitored by sensors throughout the entire operational mission.

In another example, after repeated uncoupling and coupling, the aircraft unit differs structurally to a small extent from each other, for example due to different external influences. Deformation associated therewith, which would normally be transmitted through the entire supplemented aircraft unit and is interrupted by the coupling in this case, can be compensated for by the monitoring of the aircraft sections by the communication unit. In one example, the relative position of the tail assembly to the wings differs. The communication system is capable of detecting this and communicating it to the aircraft sections. These can then adjust the corresponding flight parameters in such a manner that the relative position of the tail assembly to the wings can be compensated.

In one option, in an emergency in the air or on the ground, one aircraft section can be uncoupled and another aircraft section can perform an emergency operation, so that the two aircraft sections move apart relative to one another. The two aircraft sections in this case may have parachutes, in order to intercept a fall from the air.

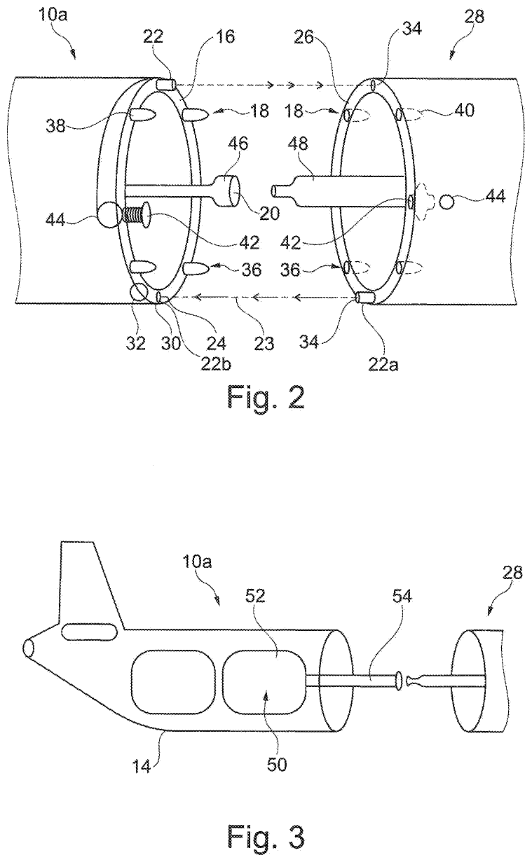

FIG. 2 shows schematically a detailed view of a coupling point of the aircraft section. The coupling point comprises the data transmission device 22 which has transmitter and receiver units 22a, 22b that allow data 23 to be exchanged bidirectionally with a complementary second coupling point 26 of another aircraft section 28.

In one example in FIG. 2, the positioning sensor system 24 is equipped with sensors 30 and controllers 32 that allow position detection, steering, and centering of the first aircraft section with another aircraft section relative to one another.

In another example in FIG. 2, the data transmission device and the positioning sensor system use the same shared data communication device 34.

In one example, the data communication device 34 comprises a communication device comprising transmitters, receivers, and processing units. For example, data communication takes place by means of light waves, e.g., via laser.

In another example, data communication takes place by means of sound waves and/or matter waves. In another example, data communication takes place by means of magnetic and/or electric fields. In one example, the polarization property of light waves can be utilized. In one example, the propagation of matter waves may occur through the fuselage or the structural elements of the supplemented aircraft unit.

In another example in FIG. 2, the mechanical coupling 18 comprises at least three coupling units 36. The at least three coupling units 36 have a positioning dowel 38 for mounting in a receptacle of a complementary coupling part or a receptacle 40 for holding a positioning dowel of a complementary coupling part. In one option, the positioning dowel and the receptacle are designed to form structural stability and centering of the mechanical coupling of the coupling parts.

In another example, the mechanical coupling 18 includes more than three of the coupling units 36, for example four or five or more of the coupling units 36.

In another example in FIG. 2, the complementary coupling parts form a coupling unit. At least one of the coupling units 36 has a self-locking bolt lock 42 which is designed to form a controllable closure of the coupling unit. In one option, the bolt lock 42 has a controller 44 that is in data exchange with the data transmission device 22. The bolt lock 42 ensures that the integrity check of the aircraft is only possible when the coupling units 36 are locked.

In another example in FIG. 2, the system infrastructure interface 20 includes first supply line connection points 46 which are designed to be complementary to second supply line connection points 48 of the other aircraft section. The supply line connection points 46, 48 are designed to be reversibly couplable at the coupling points.

FIG. 3 shows schematically an example of the aircraft section 10a with a hydrogen tank device 50. The hydrogen tank device 50 has at least one tank unit 52 for storing hydrogen. The at least one tank unit 52 forms a structurally integrated unit with the first fuselage component 14. Hydrogen lines 54 are preferably provided which are configured to convey hydrogen from the hydrogen tank device 50 of the first aircraft section to consumers in the other aircraft section 28. For reversible coupling with the other aircraft section, the hydrogen lines 54 are designed at the first coupling point with a first line coupling for connection to a complementary second line coupling.

In one example, communications devices are provided that are configured to monitor the status of the hydrogen tanks and/or the hydrogen lines in addition.

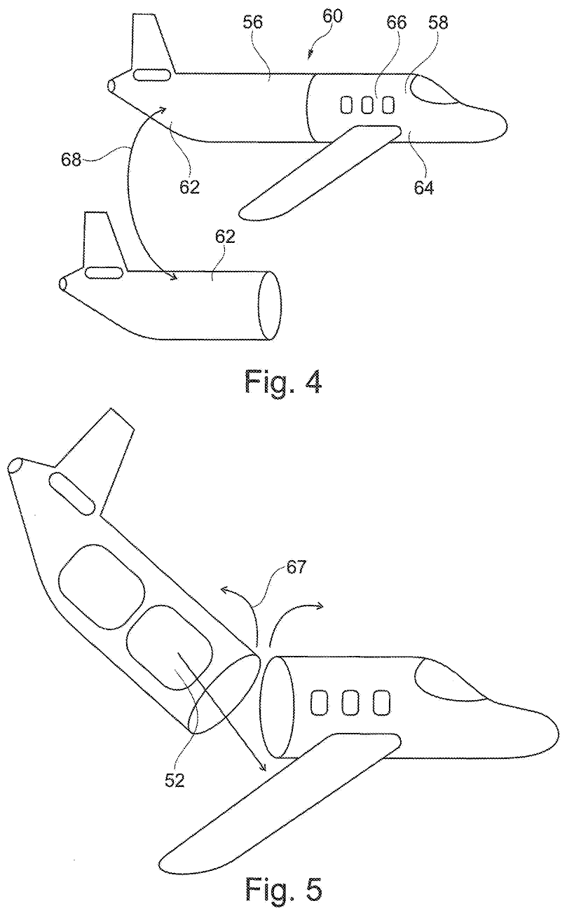

FIG. 4 shows schematically an example of an aircraft with two aircraft sections. The aircraft section is a tail section 56 and the at least one flight component includes a tail assembly. The tail assembly comprises a vertical stabilizer and a horizontal stabilizer. For example, a passenger section, the flight component of which includes wings comprising engines, is then provided as the other aircraft section.

In one example, the aircraft section is a passenger section 58 and the at least one flight component includes wings comprising engines. The passenger section has a cabin area that can be pressurized, for example.

For example, a tail section, the flight component of which has a tail assembly comprising a vertical stabilizer and a horizontal stabilizer, is then provided as the other aircraft section.

In one example, landing gear is provided in the passenger section.

In one example of FIG. 4, an aircraft comprises a first aircraft section 62 according to any of the preceding examples and a second aircraft section 64 according to any one of the preceding examples. The second aircraft section is designed to be complementary to the first aircraft section and, when coupled with the first aircraft section, forms an integrated aircraft 66.

In one example, the first aircraft section is a tail section and the second aircraft section is a passenger section. The tail section includes a tail assembly comprising a vertical stabilizer and a horizontal stabilizer. The passenger section includes a cabin area and wings comprising engines.

In one example, hydrogen tanks are housed in the tail section. The tail section can be completely removed, for example. When removed, the integrity of the aircraft is disrupted (temporarily). When the two aircraft sections are repositioned and coupled together again, the integrity of the aircraft is restored and can be checked and verified by onboard means.

In one example, the hydrogen tanks are housed at the rear end of a main section, i.e. at the rear end of the passenger section.

In one example in FIG. 4, a plurality of first or second aircraft sections is provided. The two aircraft sections are configured in such a manner that the first and/or second aircraft section can be exchanged with at least one other first and/or second aircraft section (see the first double arrow 68) to form a structurally and functionally integrated aircraft. For example, the aircraft with the interchangeable sections forms a kind of modular or aircraft system that allows for easier refueling of hydrogen tanks and also faster turn-around times.

FIG. 5 shows schematically an example of an aircraft with a retractable aircraft section and removable tank units. The tail section can be completely removed, for example, or at least folded away (see the second double arrow 67), so that the tank unit 52 used for storing hydrogen can be removed. Filled hydrogen tanks can then be used again. When folded away or removed, the integrity of the aircraft is disrupted (temporarily). When the two aircraft sections are repositioned and coupled together again, the integrity of the aircraft is restored and can be checked and verified by onboard means.

In one example, it is provided that the first aircraft section, for example the tail section, is exchanged for another first aircraft section, for example for refueling or for maintenance or repair purposes.

In one example, it is provided that the second aircraft section, for example the passenger section, is exchanged for another second aircraft section, for example for reconfiguring the cabin area or for maintenance or repair purposes.

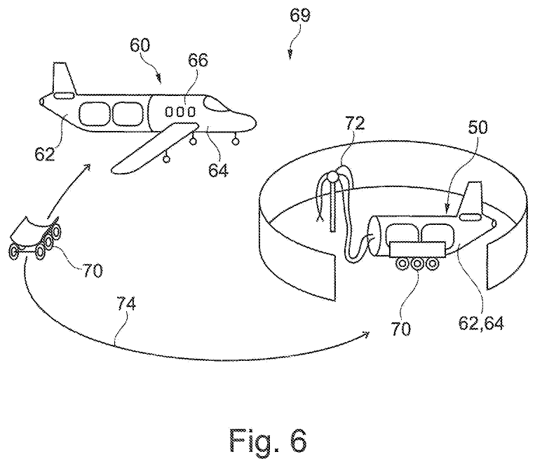

FIG. 6 shows schematically an example of a hydrogen refueling system 69 for aircraft. The hydrogen refueling system 69 for aircraft includes an example of the aircraft 60 according to any one of the preceding examples. One of the two aircraft sections 62, 64 is equipped with a hydrogen tank device. The system also comprises at least one transport system 70 for one of the two aircraft sections and a hydrogen refueling station 72. The aircraft section with the hydrogen tank device can be decoupled from the other aircraft section, and with the transport system, a spatial distance 74 between the two aircraft sections can be created. The aircraft section with the hydrogen tank device can be refueled while at a spatial distance from the other aircraft section, and the aircraft sections can then be coupled to form a fueled integrated aircraft.

In one example, a communication system is provided. For example, the transport system has a communication device that communicates with the communication device of the aircraft sections and with the hydrogen tank device.

In one example, a transport system is provided that is configured to move the first aircraft section. The transport system includes a transport frame that is designed to maintain the structural integrity of the first aircraft section during transportation. The transport system has landing gear that is configured for positioning for decoupling and coupling at the coupling point of the first aircraft section in the target position. The transport system includes a transport communication device that is configured to interact with the communication devices of the coupling point.

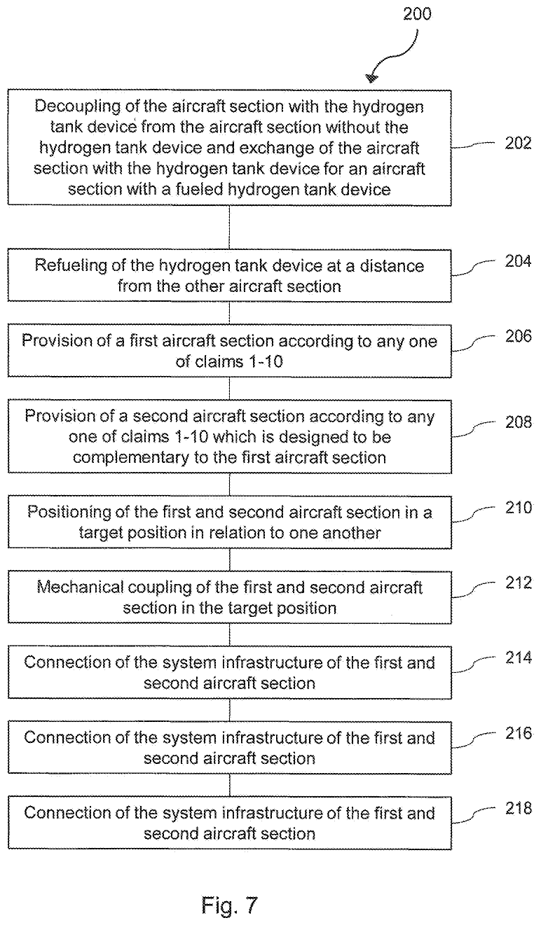

FIG. 7 illustrates basic steps of an example of a method 200 for providing an aircraft with a quick-release system. In a first step 206, a first aircraft section is provided according to any one of the preceding examples. In another step 208, a second aircraft section is provided according to any one of the preceding examples, which is designed to be complementary to the first aircraft section. In a next step 210, the first and the second aircraft sections are positioned in a target position in relation to one another. In a subsequent step 212, the first and the second aircraft sections are mechanically coupled in the target position. In another step 214, the system infrastructure of the first and the second aircraft section is interconnected. In a further step 216, the integrity of the aircraft is checked internally onboard, and in yet another step 218, flight operations are cleared when integrity is confirmed. In one example of the method, the positioning of the first aircraft section with the second aircraft section further comprises a two-stage process in which rough adjustment and fine-tuning are provided.

In one example in FIG. 7, one of the two aircraft sections has a hydrogen tank device and both aircraft sections form an integrated aircraft. In this case, the method starts at step 202, before the steps of providing or positioning 206, 208, 210. In a first preceding step 202, the aircraft sections with the hydrogen tank device are decoupled from the aircraft section without the hydrogen tank device, and the aircraft section with the hydrogen tank device is exchanged for an aircraft section with a fueled hydrogen tank device.

In another option, a second preceding step 204 is provided, in which the hydrogen tank device is refueled at a distance from the other aircraft section.

It should be noted that embodiments of the invention are described with reference to different subjects. In particular, some embodiments are described with reference to the claims of the method type, while other embodiments are described with reference to the claims of the device type. However, a person skilled in the art will infer from the foregoing and the following description that, unless otherwise indicated, in addition to any combination of features belonging to one kind of subject matter, any combination of features relating to different subject matters will also be regarded as disclosed in this application. However, all features can be combined to achieve synergistic effects that go beyond the mere sum of the features.

Although the invention is presented and described in detail in the drawings and the foregoing description, presentations and descriptions of this kind are to be regarded as illustrative or exemplary and not as restrictive. The invention is not limited to the disclosed embodiments. Other variations of the disclosed embodiments can be understood and executed by a person skilled in the art when implementing the invention as claimed with the help of the drawings, the disclosure, and the dependent claims.

The systems and devices described herein may include a controller or a computing device comprising a processing and a memory which has stored therein computer-executable instructions for implementing the processes described herein. The processing unit may comprise any suitable devices configured to cause a series of steps to be performed so as to implement the method such that instructions, when executed by the computing device or other programmable apparatus, may cause the functions/acts/steps specified in the methods described herein to be executed. The processing unit may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

The memory may be any suitable known or other machine-readable storage medium. The memory may comprise non-transitory computer readable storage medium such as, for example, but not limited to, an electronic, magnetic, optical, electromagnetic, infrared, or semiconductor system, apparatus, or device, or any suitable combination of the foregoing. The memory may include a suitable combination of any type of computer memory that is located either internally or externally to the device such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. The memory may comprise any storage means (e.g., devices) suitable for retrievably storing the computer-executable instructions executable by processing unit.

The methods and systems described herein may be implemented in a high-level procedural or object-oriented programming or scripting language, or a combination thereof, to communicate with or assist in the operation of the controller or computing device. Alternatively, the methods and systems described herein may be implemented in assembly or machine language. The language may be a compiled or interpreted language. Program code for implementing the methods and systems described herein may be stored on the storage media or the device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein.

Computer-executable instructions may be in many forms, including modules, executed by one or more computers or other devices. Generally, modules include routines, programs, objects, components, data structures, etc., that perform particular tasks or implement particular abstract data types. Typically, the functionality of the modules may be combined or distributed as desired in various embodiments.

It will be appreciated that the systems and devices and components thereof may utilize communication through any of various network protocols such as TCP/IP, Ethernet, FTP, HTTP and the like, and/or through various wireless communication technologies such as GSM, CDMA, Wi-Fi, and WiMAX, is and the various computing devices described herein may be configured to communicate using any of these network protocols or technologies.

In the claims, the word “comprising” does not exclude other elements or steps, and the indefinite article “a” or “an” does not exclude a plurality. A single processor or another unit may fulfill the functions of multiple items listed in the claims. The mere fact that certain measures are repeatedly mentioned in various dependent claims does not mean that a combination of these measures cannot be advantageous. Any reference signs in the claims are not to be construed as limiting the scope of application.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

Claimed is:

1. An aircraft section for an aircraft, the aircraft section comprising:
at least one flight component from a group consisting of: a wing assembly and a tail assembly; and
a first fuselage component;
wherein the at least one flight component is mounted on the first fuselage component;
wherein the first fuselage component has a first coupling point designed for releasable connection to a second coupling point on a second fuselage component, in order to form an integrated fuselage of the aircraft when in a coupled state;
wherein the first coupling point is configured to provide a mechanical coupling with the second coupling point, to create a system infrastructure interface, and to provide a data transmission device for integrity checking when the aircraft section is coupled to a second aircraft section, and
wherein the first coupling point comprises positioning sensors for guided docking of the aircraft section with the second aircraft section in a target position.

2. The aircraft section as claimed in claim 1, wherein the data transmission device comprises transmitter and receiver units, with which data is exchanged bidirectionally with a complementary second coupling point of another aircraft section.

3. The aircraft section as claimed in claim 1, wherein the positioning sensors comprise sensors and controls configured to allow position sensing, steering, and centering of the aircraft section relative to another aircraft section.

4. The aircraft section as claimed in claim 1, wherein the data transmission device and the positioning sensors utilize a data communication device that is the same.

5. The aircraft section as claimed in claim 1, wherein the mechanical coupling comprises at least three coupling units which each have:
i) a positioning dowel for mounting in a receptacle of a complementary coupling part; or
ii) a receptacle for holding a positioning dowel of a complementary coupling part;
wherein the positioning dowel and the receptacle are configured to provide structural stability and centering for the mechanical coupling of the coupling parts.

6. The aircraft section as claimed in claim 1, wherein the first and second coupling parts form a coupling unit,
wherein at least one coupling unit has a self-locking bolt lock configured to form a controllable closure of the coupling unit, and
wherein the bolt lock comprises a controller that is in data communication with the data transmission device.

7. The aircraft section as claimed in claim 1, wherein the system infrastructure interface comprises first supply line connection points which are configured complementary to second supply line connection points of the second aircraft section, and
wherein the supply line connection points are configured to be reversibly couplable at the coupling points.

8. The aircraft section as claimed in claim 1, further comprising:
a hydrogen tank device with at least one tank unit for storing hydrogen,
wherein the at least one tank unit forms a structurally integrated unit with the first fuselage component,
wherein hydrogen lines are provided which are configured to convey hydrogen from the hydrogen tank device of the aircraft section to consumers in the second aircraft section,
wherein, for reversible coupling with the second aircraft section, the hydrogen lines are configured, at the first coupling point, with a first line coupling for connection to a complementary second line coupling.

9. The aircraft section as claimed in claim 1, wherein the aircraft section is a tail section and wherein the at least one flight component includes the tail assembly, and wherein the tail assembly comprises a vertical stabilizer and a horizontal stabilizer.

10. The aircraft section as claimed in claim 1, wherein the aircraft section is a passenger section, and wherein the at least one flight component comprises the wing assembly, the wing assembly including a wing and an engine.

11. An aircraft comprising:
two aircraft sections as claimed in claim 1;
wherein a second aircraft section of the two aircraft sections is designed to be complementary to a first aircraft section of the two aircraft sections, and,
wherein, when coupled together, the two aircraft sections form an integrated aircraft.

12. The aircraft as claimed in claim 11, wherein the two aircraft sections are configured in such a manner that the first aircraft section, the second aircraft section, or both are exchangeable with a third aircraft section, in order to form the integrated aircraft.

13. A hydrogen refueling system for aircraft comprising:
the aircraft as claimed in claim 11, wherein one of the two aircraft sections comprises a hydrogen tank device;
at least one transport system for one of the two aircraft sections; and
a hydrogen refueling station;
wherein the aircraft section with the hydrogen tank device is configured to be uncoupled from the other aircraft section and with the transport system, a spatial distance between the two aircraft sections is created,
wherein the aircraft section with the hydrogen tank device is configured to be refueled at the spatial distance, and
wherein the two aircraft sections are configured to be coupled to form a fueled integrated aircraft.

14. A method for providing an aircraft, the method comprising the following steps:
providing two aircraft sections according to claim 1;
positioning the two aircraft sections in a target position in relation to one another;
mechanical coupling the two aircraft sections in the target position;
connecting the system infrastructure of the two aircraft sections;
internally onboard checking an integrity of the aircraft; and
clearance of flight operations when the integrity is confirmed.

15. The method as claimed in claim 14, wherein one of the two aircraft sections has a hydrogen tank device and both of the two aircraft sections form an integrated aircraft; and wherein the method further includes, before the steps of providing or positioning:
uncoupling of the one aircraft section with the hydrogen tank device from the other aircraft section without the hydrogen tank device; and
exchanging of the one aircraft section with the hydrogen tank device for an aircraft section with a refueled hydrogen tank device, or
refueling of the hydrogen tank device remotely from the other aircraft section without the hydrogen tank device.
